(19) United States
(12) Patent Application Publication
(10) Pub. No.: US 2018/0332292 A1
(43) Pub. Date: Nov. 15, 2018

(54) METHOD AND APPARATUS FOR INTRA PREDICTION MODE USING INTRA PREDICTION FILTER IN VIDEO AND IMAGE COMPRESSION

(71) Applicant: MEDIATEK INC., Hsin-Chu (TW)

(72) Inventors: Jian-Liang LIN, Su'ao Township, Yilan County (TW); Yu-Wen HUANG, Taipei City (TW)

(73) Assignee: MEDIATEK INC., Hsin-Chu (TW)

(21) Appl. No.: 15/775,478

(22) PCT Filed: Nov. 16, 2016
(86) PCT No.: PCT/CN2016/106059

§ 371 Date: May 11, 2018

Related U.S. Application Data
(60) Provisional application No. 62/256,740, filed on Nov. 18, 2015.

(51) Int. Cl. H04N 19/159; H04N 19/176; H04N 19/182; H04N 19/117; H04N 19/126

(52) U.S. Cl. CPC H04N 19/159; H04N 19/176; H04N 19/126; H04N 19/117; H04N 19/182

(57) ABSTRACT

A method and apparatus of Intra prediction filtering in an image or video encoder or decoder are disclosed. The method comprises receiving input data associated with a current block (1110); determining a current Intra prediction mode belonging to a set of available Intra prediction modest for the current block (1120); according to the current Intra prediction mode, determining an initial Intra prediction block consisting of initial Intra prediction pixel values based on neighboring reconstructed samples of the current block (1130); applying Intra prediction filter to the initial Intra prediction block according to a current scanning order selected from multiple scanning orders depending on the current Intra prediction mode to generate a filtered Intra prediction block consisting of filtered Intra prediction pixel values, wherein inputs to the Intra prediction filter comprise a current pixel and one or more adjacent pixels, and said multiple scanning orders comprise at least two scanning orders selected from a vertical scanning order, a horizontal scanning order and a diagonal scanning order (1140); applying mode-dependent Intra prediction encoding or depending to the current block using the filtered Intra prediction block as a predictor for the current block (1150).

### CROSS REFERENCE TO RELATED APPLICATIONS

The present invention claims priority to U.S. Provisional Patent Application, Ser. No. 62/256,740, filed on Nov. 18, 2015. The present invention is also related to PCT Patent Application, Serial No. PCT/CN2015/096407, filed on Dec. 4, 2015, which claims priority to U.S. Provisional Patent Application, Ser. No. 62/090,625, filed on Dec. 11, 2014. The U.S. Provisional Patent Applications and PCT Patent Application are hereby incorporated by reference in their entireties.

### TECHNICAL FIELD

The present invention relates video coding. In particular, the present invention relates to advanced Intra prediction using Intra Prediction filter to improve coding efficiency of Intra prediction.

### BACKGROUND

The advances of digital video coding standards have resulted in successes of multimedia systems such as smartphones, digital TVs, and digital cameras for the past decade. After standardization activities of H.261, MPEG-1, MPEG-2, H.263, MPEG-4, and H.264/AVC, the demand for improving video compression performance have been still strong due to requirements of larger picture resolutions, higher frame rates, and better video qualities. Accordingly, various standard activities have been taken places to develop new video coding techniques, which can provide better coding efficiency than H.264/AVC. In particular, High-Efficiency Video Coding (HEVC) standard has been developed, which is based on a hybrid block-based motion-compensated transform coding architecture.

High-Efficiency Video Coding (HEVC) is a new international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block. A CU may begin with a largest CU (LCU), which is also referred as coded tree unit (CTU) in HEVC and each CU can be recursively split into four smaller CUs until the predefined minimum size is reached. Once the splitting of CU hierarchical tree is done, each CU is further split into one or more prediction units (PUs) according to prediction type and PU partition. Each CU or the residual of each CU is divided into a tree of transform units (TUs) to apply 2D transforms such as DCT (discrete cosine transform) or DST (discrete sine transform).

In general, a CTU consists of one luma coding tree block (CTB) and two corresponding chroma CTBs, a CU consists of one luma coding block (CB) and two corresponding chroma CBs, a PU consists of one luma prediction block (PB) and two corresponding chroma PBs, and a TU consists of one luma transform block (TB) and two corresponding chroma TBs. However, exceptions can occur because the minimum TB size is 4×4 for both luma and chroma (i.e., no 2×2 chroma TB supported for 4:2:0 colour format) and each Intra chroma CB always has only one Intra chroma PB regardless of the number of Intra luma PBs in the corresponding Intra luma CB.

For an Intra CU, the luma CB can be predicted by one or four luma PBs, and each of the two chroma CBs is always predicted by one chroma PB, where each luma PB has one Intra luma prediction mode and the two chroma PBs share one Intra chroma prediction mode. Moreover, for the Intra CU, the TB size cannot be larger than the PB size. In each PB, the Intra prediction is applied to predict samples of each TB inside the PB from neighbouring reconstructed samples of the TB. For each PB, in addition to 33 directional Intra prediction modes, DC and planar modes are also supported to predict flat regions and gradually varying regions, respectively.

For each Inter PU, one of three prediction modes including Inter, Skip, and Merge, can be selected. Generally speaking, a motion vector competition (MVC) scheme is introduced to select a motion candidate from a given candidate set that includes spatial and temporal motion candidates. Multiple references to the motion estimation allow for finding the best reference in two possible reconstructed reference picture lists (namely List 0 and List 1). For the Inter mode (unofficially termed AMVP mode, where AMVP stands for advanced motion vector prediction), Inter prediction indicators (List 0, List 1, or bi-directional prediction), reference indices, motion candidate indices, motion vector differences (MVDs) and prediction residual are transmitted. As for the Skip mode and the Merge mode, only Merge indices are transmitted, and the current PU inherits the Inter prediction indicator, reference indices, and motion vectors from a neighbouring PU referred by the coded Merge index. In the case of a Skip coded CU, the residual signal is also omitted. Quantization, entropy coding, and deblocking filter (DF) are also in the coding loop of HEVC. The basic operations of these three modules are conceptually similar to those used in H.264/AVC, but differ in details.

Sample adaptive offset (SAO) is a new in-loop filtering technique applied after DF. SAO aims to reduce sample distortion by classifying deblocked samples into different categories and then adding an offset to deblocked samples of each category.

FIG. 1 illustrates an exemplary adaptive Inter/Intra video coding system incorporating loop processing based on HEVC. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion, coding modes, and other information associated with the image area. The side information may also be compressed by entropy coding to reduce required bandwidth. Accordingly, the data associated with the side information are provided to Entropy Encoder 122 as shown in FIG. 1. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1, incoming video data undergoes a series of processing in the encoding system. The reconstructed video data from REC 128 may be subject to various impairments due to a series of processing. Accordingly, Loop filters including deblocking filter (DF) 130 and Sample Adaptive Offset (SAO) 132 have been used in the High Efficiency Video Coding (HEVC) standard. The loop filter information (e.g. SAO) may have to be incorporated in the bitstream so that a decoder can properly recover the required information. Therefore, loop filter information is provided to Entropy Encoder 122 for incorporation into the bitstream. In FIG. 1, DF 130 and SAO 132 are applied to the reconstructed video before the reconstructed samples are stored in the reference picture buffer 134.

Intra Prediction Modes

In HEVC, the decoded boundary samples of adjacent blocks are used as reference data for spatial prediction in regions where Inter picture prediction is not performed. All TUs within a PU use the same associated Intra prediction mode for the luma component and the chroma components. The encoder selects the best luma Intra prediction mode of each PU from 35 options: 33 directional prediction modes, a DC mode and a Planar mode. The 33 possible Intra prediction directions are illustrated in FIG. 2. The mapping between the Intra prediction direction and the Intra prediction mode number is specified in FIG. 3.

For the chroma component of an Intra PU, the encoder selects the best chroma prediction modes among five modes including Planar, DC, Horizontal, Vertical and a direct copy of the Intra prediction mode for the luma component. The mapping between Intra prediction direction and Intra prediction mode number for chroma is shown in Table 1.

TABLE 1

| | Intra prediction direction | | | | |
|---|---|---|---|---|---|
| | | | | | X |
| intra_chroma_pred_mode | 0 | 26 | 10 | 1 | (0 <= X <= 34) |
| 0 | 34 | 0 | 0 | 0 | 0 |
| 1 | 26 | 34 | 26 | 26 | 26 |
| 2 | 10 | 10 | 34 | 10 | 10 |
| 3 | 1 | 1 | 1 | 34 | 1 |
| 4 | 0 | 26 | 10 | 1 | X |

When the Intra prediction mode number for the chroma component is 4, the Intra prediction direction for the luma component is used for the Intra prediction sample generation for the chroma component. When the Intra prediction mode number for the chroma component is not 4 and it is identical to the Intra prediction mode number for the luma component, the Intra prediction direction of 34 is used for the Intra prediction sample generation for the chroma component.

Filtering of Neighbouring Reconstructed Samples

For the luma component, the neighbouring reconstructed samples from the neighbouring reconstructed blocks used for Intra prediction sample generations are filtered before the generation process. The filtering is controlled by the given Intra prediction mode and transform block size. If the Intra prediction mode is DC or the transform block size is equal to 4×4, neighbouring reconstructed samples are not filtered. If the distance between the given Intra prediction mode and vertical mode (or horizontal mode) is larger than predefined threshold, the filtering process is enabled. The predefined threshold is specified in Table 2, where nT represents the transform block size.

TABLE 2

| | nT = 8 | nT = 16 | nT = 32 |
|---|---|---|---|
| Threshold | 7 | 1 | 0 |

For neighbouring reconstructed sample filtering, [1, 2, 1] filter and bi-linear filter are used. The bi-linear filtering is conditionally used if all of the following conditions are true.
strong_Intra_smoothing_enable_flag is equal to 1;
transform block size is equal to 32;
Abs(p[−1][−1]+p[nT*2−1][−1]−2*p[nT−1][−1])<(1<<(BitDepthY−5));
Abs(p[−1][−1]+p[−1][nT*2−1]−2*p[−1][nT-1])<(1<<(BitDepthY−5)).

Boundary Filtering for DC, Vertical and Horizontal Prediction Modes

For DC mode in the HEVC, a boundary filter (or smoothing filter) is applied on DC mode. The boundary prediction samples of DC mode will be smoothed with a [1, 3] or [1, 2, 1] filter to reduce the blocking artefact as shown in FIG. 4. In FIG. 4, bold line 410 indicates a horizontal block boundary and bold line 420 indicates a vertical block boundary. The filter weights for filtering the edge pixels and the corner pixel are shown in block 430.

For vertical and horizontal Intra prediction directions, a gradient based boundary filter is applied according to current HEVC standard. FIG. 5 shows an example for the gradient based boundary smoothing filter for vertical Intra prediction direction. The prediction pixels for the first column of the current block are smoothed according to

Pᵢ=P+

[symbol]

i=0, 1, 2, . . . , (N−1) and N is the block height. For horizontal Intra prediction, the boundary smoothing can be derived similarly for the first row in the current block.

### SUMMARY

A method and apparatus of Intra prediction filtering in an image or video encoder or decoder are disclosed. In one embodiment, an initial Intra prediction block consisting of initial Intra prediction pixel values is determined based on neighbouring reconstructed samples of the current block. Intra prediction filter is applied to each pixel of the initial Intra prediction block to generate a filtered Intra prediction block consisting of filtered Intra prediction pixel values. Inputs to the Intra prediction filter comprise a current pixel and one or more adjacent pixels including at least one pixel below or adjacent to the right side of the current pixel. Intra prediction encoding or decoding is then applied to the current block using the filtered Intra prediction block as a predictor for the current block.

The Intra prediction filter generates one filtered Intra prediction pixel value for each pixel in the current block according to a weighted sum of the inputs to the Intra prediction filter using a set of weighting coefficients. For example, four adjacent pixels located below, above, adjacent to the right side and adjacent to the left side of the current pixel can be used as inputs to the Intra prediction filter and the set of weighting coefficients for the current pixels and the four adjacent pixels corresponds 4, 1, 1, 1 and 1 respectively. The set of weighting coefficients can be signalled in a video bitstream associated with compressed data including the current block. The set of weighting coefficients can be signalled in syntax level or header corresponding to a sequence, view, picture, slice, SPS (Sequence Parameter Set), VPS (Video Parameter Set), APS (Adaptation Parameter Set), CTU (coding tree unit), CTB (coding tree block), LCU (largest coding unit), CU (coding unit), PU (prediction unit), TU or a combination thereof. The set of weighting coefficients can be derived according to a Wiener filter derivation process using original pixel values and the filtered Intra prediction pixel values as input data to the Wiener filter derivation process. Also, the Wiener filter derivation process may use original pixel values and neighbouring reconstructed pixel values as input data.

The Intra prediction filter may correspond to a FIR (finite impulse response) filter, where a reference value at the input is used for the Intra prediction filter when the input is located in a neighbouring reconstructed block above or adjacent to the left side of the current block, and an initial Intra prediction value at the input is used for the Intra prediction filter when the input is located in the current block. The Intra prediction filter may correspond to an IIR (infinite impulse response) filter, where a reference value at the input is used for the Intra prediction filter when the input is located in a neighbouring reconstructed block above or adjacent to the left side of the current block, a filtered Intra prediction pixel values at the input is used for the Intra prediction filter when the input corresponds to an adjacent pixel in the current block that has been processed by the Intra prediction filter, and one initial Intra prediction value at the input is used for the Intra prediction filter when the input corresponds to an adjacent pixel in the current block that has not been processed by the Intra prediction filter.

Another method and apparatus of Intra prediction filtering in an image or video encoder or decoder are disclosed. In one embodiment, a current Intra prediction mode belonging to a set of available Intra prediction modes is determined for the current block. According to the current Intra prediction mode, an initial Intra prediction block consisting of initial Intra prediction pixel values is determined based on neighbouring reconstructed samples of the current block. An Intra prediction filter is applied to the initial Intra prediction block according to a current scanning order selected from multiple scanning orders depending on the current Intra prediction mode to generate a filtered Intra prediction block consisting of filtered Intra prediction pixel values, where inputs to the Intra prediction filter comprise a current pixel and one or more adjacent pixels. The multiple scanning orders comprise at least two scanning orders selected from a vertical scanning order, a horizontal scanning order and a diagonal scanning order. Intra prediction encoding or decoding is then applied to the current block using the filtered Intra prediction block as a predictor for the current block.

In one example of this embodiment, shape of the Intra prediction filter is dependent on the current scanning order. The Intra prediction filter can be enabled or disabled according to a flag. The flag can be explicitly signalled in a bitstream associated with compressed data including the current block or implicitly derived at a decoder side. When the flag is implicitly derived at a decoder side, the flag is derived according to the current Intra prediction mode, or one or more Intra prediction modes of one or more neighbouring blocks processed prior to the current block. The flag indicating whether the Intra prediction filter is enabled or disabled depends on whether the current Intra prediction mode, or one or more Intra prediction modes of one or more neighbouring blocks processed prior to the current block belong to a predetermined subset of the available Intra prediction mode set. When the flag is explicitly signalled in a bitstream, the flag is signalled in syntax level or header corresponding to a sequence, view, picture, slice, SPS (Sequence Parameter Set), VPS (Video Parameter Set), APS (Adaptation Parameter Set), CTU (coding tree unit), CTB (coding tree block), LCU (largest coding unit), CU (coding unit), PU (prediction unit), TU or a combination thereof.

When the current block corresponds to colour image or video data comprising a luminance component and one or more chrominance components, Intra prediction filter can be enabled for only the luminance component, only said one or more chrominance components, or both. When the current block corresponds to colour image or video data comprising a green component, a red component and a blue component, Intra prediction filter can be enabled for only the green component, only the red component, only the blue component, or an combination thereof.

### BRIEF DESCRIPTION OF DRAWINGS

FIG. 1 illustrates an exemplary adaptive Inter/Intra video coding system incorporating loop processing based on the High Efficiency Video Coding (HEVC) standard.

FIG. 2 illustrates the 33 possible Intra prediction directions based on the High Efficiency Video Coding (HEVC) standard.

FIG. 3 illustrates the mapping between the Intra prediction direction and the Intra prediction mode number according to the High Efficiency Video Coding (HEVC) standard.

FIG. 4 illustrates the boundary prediction samples of DC mode that are smoothed with a [1, 3] or [1, 2, 1] filter to reduce the blocking artefact.

FIG. 5 illustrates an example for the gradient based boundary smoothing filter for vertical Intra prediction direction.

FIG. 6 illustrates an example of Intra prediction filter applied to the initial Intra prediction samples according to an embodiment of the present invention.

FIGS. 7A-7B illustrate an example of an Intra prediction filter according to an embodiment of the present invention, where the Intra prediction filtering uses a horizontal scanning order in FIG. 7A and a vertical scanning order in FIG. 7B.

FIGS. 8A-8B illustrate another example of an Intra prediction filter according to an embodiment of the present invention, where the Intra prediction filtering uses a horizontal scanning order in FIG. 8A and a vertical scanning order in FIG. 8B.

FIGS. 9A-9B illustrate yet another example of an Intra prediction filter according to an embodiment of the present invention, where the Intra prediction filtering uses a horizontal scanning order in FIG. 9A and a vertical scanning order in FIG. 9B.

FIG. 10 illustrates an exemplary flowchart of a coding system incorporating Intra prediction filtering according to an embodiment of the present invention, where inputs to the Intra prediction filter comprise a current pixel and one or more adjacent pixels including at least one pixel below or adjacent to the right side of the current pixel.

FIG. 11 illustrates an exemplary flowchart of a coding system incorporating Intra prediction filtering according to another embodiment of the present invention, where an Intra prediction filter is applied to the initial Intra prediction block according to a current scanning order selected from multiple scanning orders depending on the current Intra prediction mode.

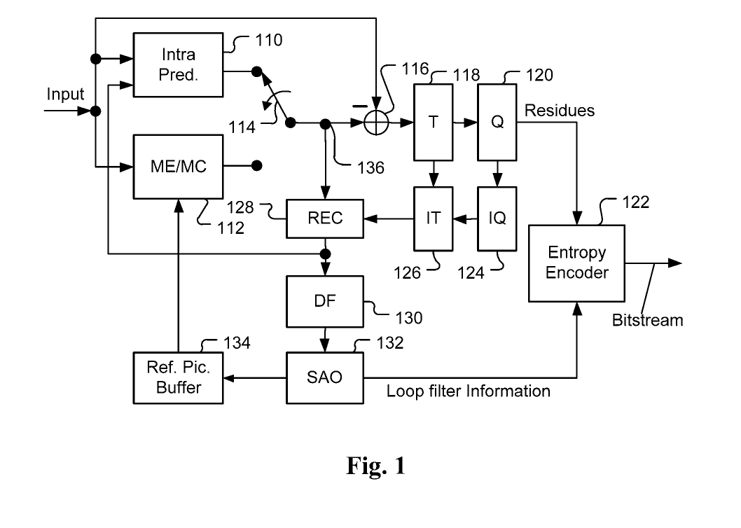

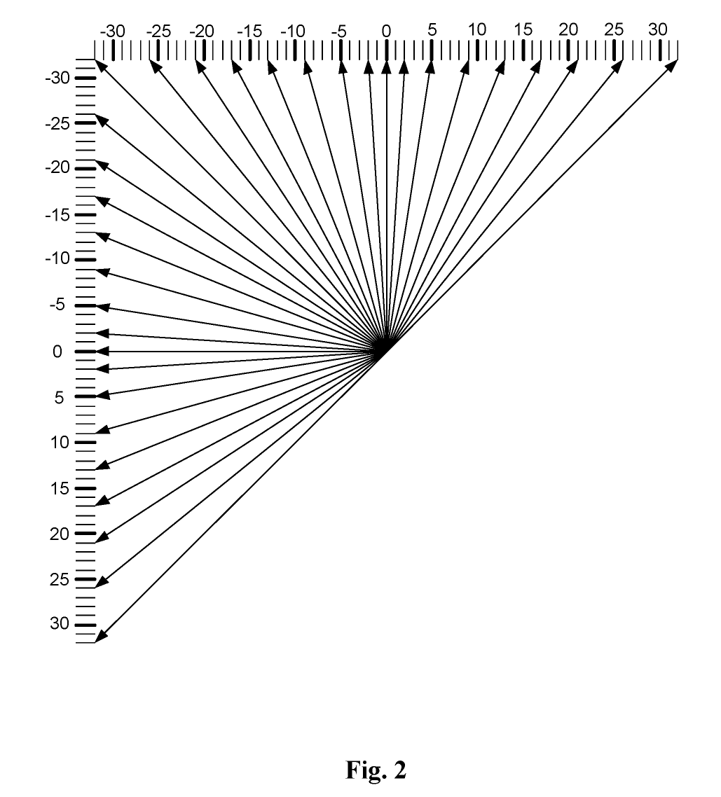

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

To improve the coding efficiency of Intra prediction, new methods to derive or refine the Intra predictor for video coding are disclosed in this invention.

In one embodiment of the present application, a filter is applied on the Intra prediction samples as illustrated in FIG. 6, according to the following equations:

$$\begin{matrix}{\hat{X}}_{n} = {a}_{0} {X}_{n} + {\sum }_{k = 1}^{N} {a}_{k} {X}_{n - k} , or & ( 1 ) \\ {\hat{X}}_{n} = {a}_{0} {X}_{n} + {\sum }_{k = 1}^{N} {a}_{k} {\hat{X}}_{n - k} . & ( 2 )\end{matrix}$$

In the above equations, Xₙ represents Intra prediction sample that is initially generated according to a conventional Intra prediction method and \hat{X}ₙ represents filtered sample. As is known in the art, the initial Intra prediction block can be generated according to a selected Intra prediction mode. The encoder selects an Intra prediction mode from a set of allowed Intra prediction modes (e.g., the 35 modes as defined in HEVC). The mode selection process is known in the field and the details are omitted herein. According to the present method, as shown in FIG. 6, the inputs to the Intra prediction filter include at least one pixel below the current pixel or one pixel to the right side of the current pixel. In the example shown in FIG. 6, N equals to 4. In other words, four adjacent pixels (i.e., above, below, adjacent to the right side and adjacent to the left side of the current pixel) and the current pixel are used to derive a new predictor (referred as filtered Intra prediction samples) as the refined prediction sample for current pixel. For those non-boundary pixels, where the weighting factor for the current pixel is 4/8 and the weighting factor for the adjacent pixels is 1/8. For the boundary pixels, the weighting factor of the unavailable adjacent pixels is directly added to the weighting factor for the current pixel. In FIG. 6, pixels in the current block 610, an above row 620 and a left column 630 are considered as available. Pixels in the above row 620 correspond to reference pixels in the reconstructed block above the current block 610. Pixels in the left column 630 correspond to reference pixels in the reconstructed block adjacent to the left side of the current block 610. Pixels below and pixels adjacent to the right side of the current block 610 are considered unavailable. Accordingly, at least one adjacent pixel for pixel locations 642, 644 and 646 is unavailable. The weight for the unavailable pixel is assigned to zero and the weight is added to the centre pixel. Therefore the weighting for the centre pixels are 5, 6 and 5 for pixel locations 642, 644 and 646 respectively.

According to one embodiment of the present invention, the adjacent pixels can be composed by any subset of the prediction samples in the current Intra prediction block and the neighbouring reconstructed samples adjacent to current Intra prediction block. As illustrated in FIG. 6, when the adjacent pixel is located within the current Intra prediction block 610, the Intra prediction sample (i.e., the initial Intra prediction sample) is used in the filtering operation. If the adjacent pixel is in the adjacent block (either above the current block 610 or to the left of the current block 610), the neighbouring reconstructed sample is used.

According to the present embodiment, the filter can be a finite impulse response (FIR) filter, where the filter input is a subset of the initial Intra prediction samples generated according to the Intra prediction process associated with an Intra prediction mode selected, the current prediction sample, and the neighbouring reconstructed samples. The neighbouring reconstructed sample is used when the adjacent pixel is located in the neighbouring reconstructed blocks adjacent to the current Intra prediction block. The filter can also be an infinite impulse response (IIR) filter. In this case, the filtered Intra prediction pixel value is used for the Intra prediction filter when the input corresponds to an adjacent pixel in the current block that has been processed by the Intra prediction filter. An initial Intra prediction value at the input is used for the Intra prediction filter when the input corresponds to the current pixel or an adjacent pixel in the current block that has not been processed by the Intra prediction filter. The neighbouring reconstructed sample is used when the adjacent pixel is located in the reconstructed blocks adjacent to the current Intra prediction block.

The filter coefficients (also referred to as the weighting coefficients) of the Intra prediction filter can be explicitly transmitted in the bitstream. The coefficients can be transmitted in the bitstream at a syntax level or header corresponding to a sequence, view, picture, slice, SPS (Sequence Parameter Set), VPS (Video Parameter Set), APS (Adaptation Parameter Set), CTU, CTB, LCU, CU, PU, TU or any combination of them to update the filter coefficients. In the encoder side, the filter coefficients can be derived by using the Wiener filter derivation method, which is known in the art to estimate parameters of a linear model relating original input signals and measured output signals statically. The Wiener filter derivation process relies on both the original input signals and measured output signals to derive the parameters. In one embodiment, the original pixel values and the Intra prediction samples are used to derive the filter coefficients. In another embodiment, the neighbouring reconstructed samples are used to drive the filter coefficients together with the original pixels values and the initial Intra prediction samples.

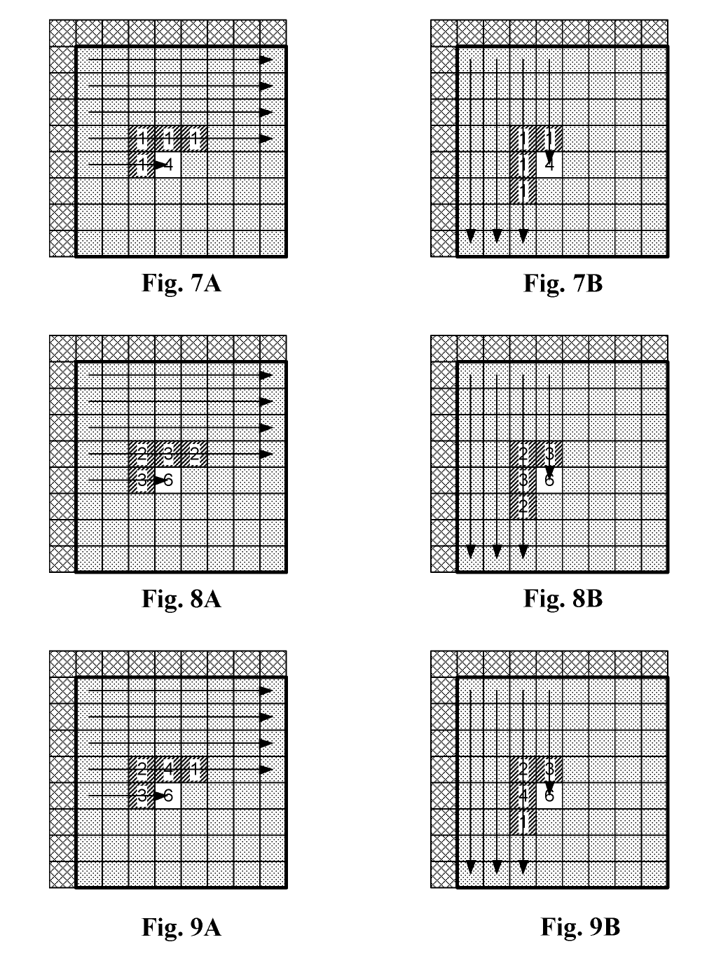

In another aspect of the present invention, the scanning order for the Intra prediction filtering is adaptively determined, and can be, for example, horizontal scanning order as shown in FIG. 7A, vertical scanning order as shown in FIG. 7B, or the diagonal scanning order.

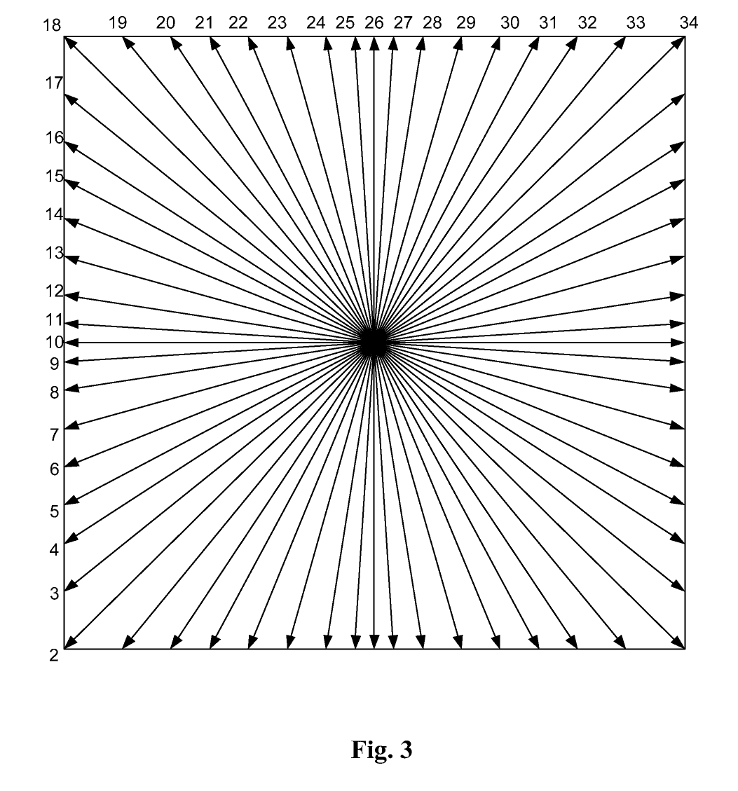

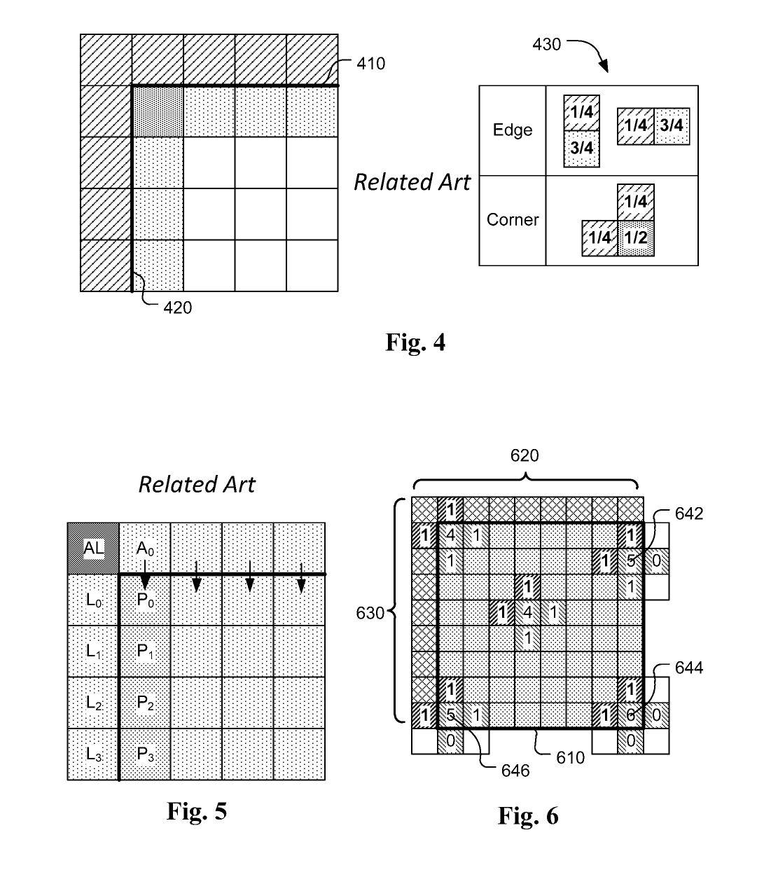

In one embodiment, the selection of the scanning order is mode dependent. For example, for the Intra prediction mode smaller than 18 as shown in FIG. 3 is horizontal/vertical scan and the remaining modes are vertical/horizontal scan. In another example, the Intra prediction mode with odd mode number as shown in FIG. 3 is horizontal/vertical scan and the remaining modes are vertical/horizontal scan.

In another embodiment, the filter depends on the scanning order. To be specific, the filter footprint such as the filter shape and/or the filter coefficients depend on the scanning order. In the example shown in FIG. 8A and FIG. 8B, if the scanning order is horizontal scan, the filter coefficients are shown in FIG. 8A. Otherwise, the filter coefficients are shown in FIG. 8B. Another example of the filter design depending on the scanning order is shown in FIG. 9A for horizontal scanning and in FIG. 9B for vertical scanning.

The filter shapes in examples shown in FIGS. 7A-B, 8A-B and 9A-B change according to the scanning order so that inputs to the Intra prediction filter corresponding to the adjacent pixels of the currently processed pixel are always processed previously.

The above Intra prediction filters can be controlled by signalling a flag explicitly or determined at the decoder side implicitly (i.e., using an implicit flag). For the implicitly control scheme, the on/off decision can be decided according to the Intra prediction mode of current processing block, or the Intra prediction mode(s) of the neighbouring process block(s). In one embodiment, the Intra prediction filter is only enabled for the Intra prediction modes belong to a predetermined subset of the available Intra prediction mode set. For example, the Intra prediction filter is enabled for the odd Intra prediction mode numbers and is disabled for the even Intra prediction mode numbers. In another example, the Intra prediction filter is disabled for the odd Intra prediction mode numbers and is enabled for the even Intra prediction mode numbers.

In yet another example, the Intra prediction filter is enabled for the odd Intra prediction mode numbers except for the DC mode and is disabled for the even Intra prediction mode numbers and DC mode. In another example, the Intra prediction filter is disabled for the odd Intra prediction mode numbers except for the DC mode and is enabled for the even Intra prediction mode numbers and DC mode.

In still yet another example, the Intra prediction filter is enabled for the odd Intra prediction mode numbers and the Planer, Horizontal and Vertical modes and is disabled for the remaining mode numbers. Alternatively, the Intra prediction filter is disabled for the odd Intra prediction mode numbers and the Planer, Horizontal and Vertical modes and is enabled for the remaining mode numbers.

For the explicitly controlling flag, a flag can be signalled in syntax level or header corresponding to a sequence, view, picture, slice, SPS (Sequence Parameter Set), VPS (Video Parameter Set), APS (Adaptation Parameter Set), CTU (coding tree unit), CTB (coding tree block), LCU (largest coding unit), CU (coding unit), PU (prediction unit), TU or a combination thereof.

For colour image or video data, the proposed Intra prediction filter can be applied only to the luma component, or only applied to the chroma component or applied to both the luma and chroma components. When the Intra prediction filter is applied to both the luma and chroma components, a flag can be used to control the enabling or disabling for both luma and chroma components. In another example, a first flag is used to control the enabling or disabling for luma component and a second flag is used to control the enabling or disabling for the chroma (e.g. Cb and Cr) components. In another example, a first flag is used to control the enabling or disabling for the luma (e.g. Y) component, a second flag is used to control the enabling or disabling for the Cb component, and a third flag is used to control the enabling or disabling for the Cr component.

The Intra prediction filter may be applied only to one of red (R), green (G) and blue (B) components, or applied on more than one of (R, G, B) components. When the Intra prediction filter is applied to more than one of (R, G, B) components, a flag can be used to control the enabling or disabling for the said more than one of (R, G, B) components. In another example, a first flag is used to control the enabling or disabling for first component and a second flag is used to control the enabling or disabling for the second and third components. In another example, a first flag is used to control the enabling or disabling for the first component, a second flag is used to control the enabling or disabling for the second component, and a third flag is used to control the enabling or disabling for the third component.

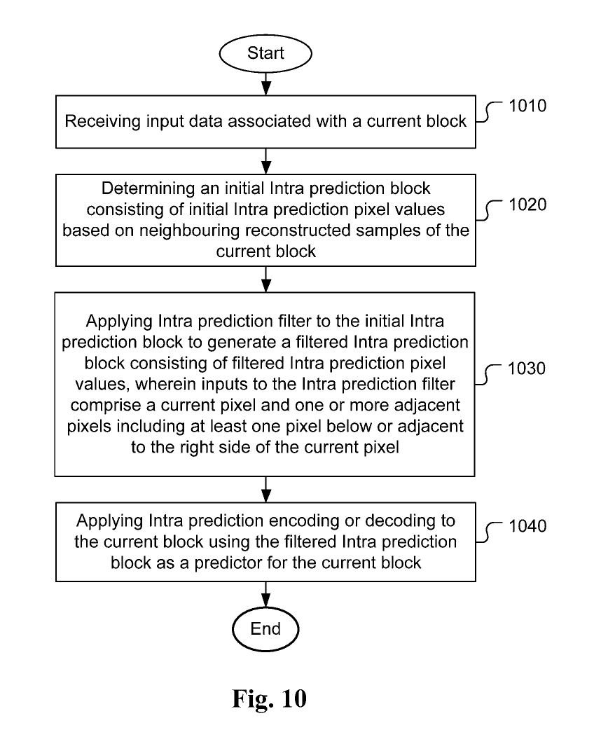

FIG. 10 illustrates an exemplary flowchart of a coding system incorporating Intra prediction filtering according to an embodiment of the present invention, where inputs to the Intra prediction filter comprise a current pixel and one or more adjacent pixels including at least one pixel below or adjacent to the right side of the current pixel. The system receives input data associated with a current block in step 1010. At the encoder side, the input data correspond to pixel data of the current block to be encoded using Intra prediction. At the decoder side, the input data correspond to bitstream or compressed data associated with the current block. An initial Intra prediction block consisting of initial Intra prediction pixel values is determined based on neighbouring reconstructed samples of the current block in step 1020. Various methods of determining initial Intra prediction block from neighbouring reconstructed samples are known in the art. For example, the initial Intra prediction block can be determined according to one of Intra prediction modes as defined in the HEVC standard. Intra prediction filter is applied to the initial Intra prediction block to generate a filtered Intra prediction block consisting of filtered Intra prediction pixel values in step 1030. Inputs to the Intra prediction filter comprise a current pixel and one or more adjacent pixels including at least one pixel below or adjacent to the right side of the current pixel. After the filtered Intra prediction block is generated, Intra prediction encoding or decoding is applied to the current block using the filtered Intra prediction block as a predictor for the current block in step 1040. As known for Intra prediction coding, the residuals between the original block and the Intra prediction block are coded.

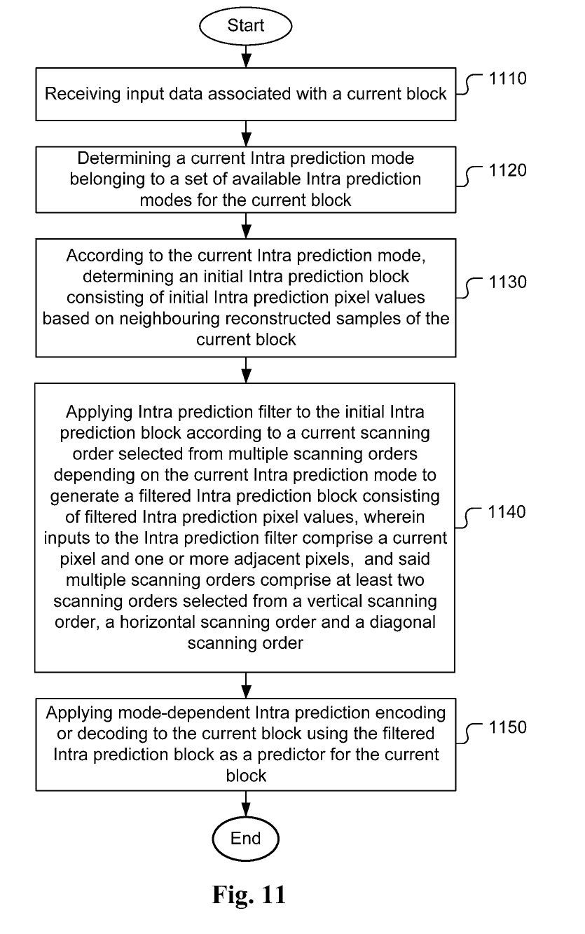

FIG. 11 illustrates an exemplary flowchart of a coding system incorporating Intra prediction filtering according to another embodiment of the present invention, where an Intra prediction filter is applied to the initial Intra prediction block according to a current scanning order selected from multiple scanning orders depending on the current Intra prediction mode of the current block. The system receives input data associated with a current block in step 1110. A current Intra prediction mode belonging to a set of available Intra prediction modes is determines for the current block in step 1120. In the encoder side, the encoder will choose an Intra prediction mode. Methods of selecting the Intra prediction mode are also known in the art. Often the encoder uses a certain performance criterion, such as the popular rate-distortion optimization (RDO) process to select a best Intra prediction mode. The mode selection is often signalled in the bitstream so that the decoder may determine the Intra prediction mode used for a current block. According to the current Intra prediction mode, an initial Intra prediction block consisting of initial Intra prediction pixel values is determined based on neighbouring reconstructed samples of the current block in step 1130. The Intra prediction filter is then applied to the initial Intra prediction block according to a current scanning order selected from multiple scanning orders depending on the current Intra prediction mode to generate a filtered Intra prediction block consisting of filtered Intra prediction pixel values in step 1140. Inputs to the Intra prediction filter comprise a current pixel and one or more adjacent pixels, and said multiple scanning orders comprise at least two scanning orders selected from a vertical scanning order, a horizontal scanning order and a diagonal scanning order. After the filtered Intra prediction block is generated, Intra prediction encoding or decoding is applied to the current block using the filtered Intra prediction block as a predictor for the current block in step 1150.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Intra prediction filtering in an image or video encoder or decoder, the method comprising:
receiving input data associated with a current block;
determining a current Intra prediction mode belonging to a set of available Intra prediction modes for the current block;
according to the current Intra prediction mode, determining an initial Intra prediction block consisting of initial Intra prediction pixel values based on neighbouring reconstructed samples of the current block;
applying an Intra prediction filter to the initial Intra prediction block according to a current scanning order selected from multiple scanning orders depending on the current Intra prediction mode to generate a filtered Intra prediction block consisting of filtered Intra prediction pixel values, wherein inputs to the Intra prediction filter comprise a current pixel and one or more adjacent pixels, and said multiple scanning orders comprise at least two scanning orders selected from a vertical scanning order, a horizontal scanning order and a diagonal scanning order; and
applying Intra prediction encoding or decoding to the current block using the filtered Intra prediction block as a predictor for the current block.

2. The method of claim 1, wherein shape of the Intra prediction filter is dependent on the current scanning order.

3. The method of claim 1, wherein the Intra prediction filter is enables or disabled according to a flag.

4. The method of claim 3, wherein the flag is explicitly signalled in a bitstream associated with compressed data including the current block or implicitly derived at a decoder side.

5. The method of claim 4, wherein when the flag is implicitly derived at the decoder side, the flag is derived according to the current Intra prediction mode, or one or more Intra prediction modes of one or more neighbouring blocks processed prior to the current block.

6. The method of claim 5, wherein the flag indicating whether the Intra prediction filter is enabled or disabled depends on whether the current Intra prediction mode, or said one or more Intra prediction modes of one or more neighbouring blocks processed prior to the current block belong to a predetermined subset of said set of available Intra prediction modes.

7. The method of claim 4, wherein when the flag is explicitly signalled in a bitstream, the flag is signalled in syntax level or header corresponding to a sequence, view, picture, slice, SPS (Sequence Parameter Set), VPS (Video Parameter Set), APS (Adaptation Parameter Set), CTU (coding tree unit), CTB (coding tree block), LCU (largest coding unit), CU (coding unit), PU (prediction unit), TU or a combination thereof.

8. The method of claim 1, wherein the current block corresponds to colour image or video data comprising a luminance component and one or more chrominance components, and wherein the Intra prediction filter is enabled for only the luminance component, only said one or more chrominance components, or both.

9. The method of claim 1, wherein the current block corresponds to colour image or video data comprising a green component, a red component and a blue component, and wherein the Intra prediction filter is enabled for only the green component, only the red component, only the blue component, or an combination thereof.

10. The method of claim 1, wherein the Intra prediction filter is mode dependent.

11. An apparatus for Intra prediction filtering in an image or video encoder or decoder, the apparatus comprising one or more electronic circuits or processors configured to:
receive input data associated with a current block;
determine a current Intra prediction mode belonging to a set of available Intra prediction modes for the current block;
according to the current Intra prediction mode, determine an initial Intra prediction block consisting of initial Intra prediction pixel values based on neighbouring reconstructed samples of the current block;
apply an Intra prediction filter to the initial Intra prediction block according to a current scanning order selected from multiple scanning orders depending on the current Intra prediction mode to generate a filtered Intra prediction block consisting of filtered Intra prediction pixel values, wherein inputs to the Intra prediction filter comprise a current pixel and one or more adjacent pixels, and said multiple scanning orders comprise at least two scanning orders selected from a vertical scanning order, a horizontal scanning order and a diagonal scanning order; and
apply Intra prediction encoding or decoding to the current block using the filtered Intra prediction block as a predictor for the current block.

12. A method of Intra prediction filtering in an image or video encoder or decoder, the method comprising:
receiving input data associated with a current block;
determining an initial Intra prediction block consisting of initial Intra prediction pixel values based on neighbouring reconstructed samples of the current block;
applying an Intra prediction filter to the initial Intra prediction block to generate a filtered Intra prediction block consisting of filtered Intra prediction pixel values, wherein inputs to the Intra prediction filter comprise a current pixel and one or more adjacent pixels including at least one pixel below or adjacent to the right side of the current pixel; and
applying Intra prediction encoding or decoding to the current block using the filtered Intra prediction block as a predictor for the current block.

13. The method of claim 12, wherein the Intra prediction filter generates one filtered Intra prediction pixel value for each pixel in the current block according to a weighted sum of the inputs to the Intra prediction filter using a set of weighting coefficients.

14. (canceled)

15. (canceled)

16. (canceled)

17. (canceled)

18. (canceled)

19. (canceled)

20. (canceled)

21. (canceled)

22. An apparatus for Intra prediction filtering in an image or video encoder or decoder, the apparatus comprising one or more electronic circuits or processors configured to:
receive input data associated with a current block;
determine an initial Intra prediction block consisting of initial Intra prediction pixel values based on neighbouring reconstructed samples of the current block;
apply an Intra prediction filter to the initial Intra prediction block to generate a filtered Intra prediction block consisting of filtered Intra prediction pixel values, wherein inputs to the Intra prediction filter comprise a current pixel and one or more adjacent pixels including at least one pixel below or adjacent to the right side of the current pixel; and
apply Intra prediction encoding or decoding to the current block using the filtered Intra prediction block as a predictor for the current block.
